(19) United States
(12) Patent Application Publication
(10) Pub. No.: US 2025/0234359 A1
(43) Pub. Date: Jul. 17, 2025

(54) MEASUREMENTS IN MULTIPATH OPERATIONS VIA SIDELINK (SL) RELAY

(71) Applicant: INTERDIGITAL PATENT HOLDINGS, INC., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(73) Assignee: INTERDIGITAL PATENT HOLDINGS, INC., Wilmington, DE (US)

(21) Appl. No.: 18/852,804

(22) PCT Filed: Apr. 26, 2023
(86) PCT No.: PCT/US2023/019993

§ 371 Date: Sep. 30, 2024

Related U.S. Application Data
(60) Provisional application No. 63/335,006, filed on Apr. 26, 2022.
(60) Provisional application No. 63/388,112, filed on Jul. 11, 2022.

(51) Int. Cl. H04W 72/25; H04W 24/10; H04W 36/36

(52) U.S. Cl. CPC H04W 72/25; H04W 24/10; H04W 36/362

(57) ABSTRACT

A wireless transmit/receive unit (WTRU) may receive, from a serving base station, configuration information including triggering conditions for a measurement event. The WTRU may receive offset values to apply to Uu radio quality measurements, wherein each offset value corresponds to a value or range of values of sidelink (SL) channel busy ratio (CBR)/channel occupation ratio (CR) radio quality, SL radio quality or both. Also, the WTRU may measure Uu radio quality, and may measure SL CBR/CR radio quality, SL radio quality, or both. The WTRU may apply an offset to the measured Uu radio quality, wherein the applied offset is determined based on an offset value, of the received offset values, that corresponds with the measured SL CBR/CR radio quality, SL radio quality or both. On a condition that the measurement event is triggered based on the received triggering conditions, the WTRU may transmit an indication including the applied offset.

### CROSS-REFERENCE TO RELATED APPLICATIONS

This application claims the benefit of U.S. Provisional Application No. 63/335,006, filed Apr. 26, 2022, and U.S. Provisional Application No. 63/388,112, filed Jul. 11, 2022, the contents of which are incorporated herein by reference.

### BACKGROUND

In wireless communication, relaying via a wireless transmit/receive unit (WTRU) to one or more network relays has been known to extend network coverage to an out of coverage WTRU using a PC5 interface between the out of coverage WTRU and a WTRU-to-network relay. In an example, the WTRU may be a ProSe WTRU. In a further example, the one or more network relays may be one or more network relay nodes. Also, the PC5 interface may be used for device-to-device (D2D) communication, in an example.

A ProSe WTRU-to-Network Relay provides a generic layer 3 (L3) forwarding function that can relay any type of internet protocol (IP) traffic between the remote WTRU and the network. One-to-one and one-to-many sidelink communications are used between the remote WTRU(s) and the ProSe WTRU-to-Network relay. For both remote WTRU and relay WTRU only one single carrier, such as a Public Safety ProSe Carrier, operation is supported. For example, Uu and PC5 should be carried on the same carrier for the relay/remote WTRU. The remote WTRU is authorized by upper layers and can be in-coverage of the Public Safety ProSe Carrier or out-of-coverage on any supported carriers, including a Public Safety ProSe Carrier for WTRU-to-Network Relay discovery, (re)selection and communication. In examples, the ProSe WTRU-to-Network Relay is always in-coverage of an evolved universal mobile telecommunications system (UMTS) terrestrial radio access network (E-UTRAN).

A first version of NR sidelink has been developed and it solely focuses on supporting vehicle-to-everything (V2X) related road safety services. V2X communications may include one or more of vehicle-to-vehicle (V2V) communications, vehicle-to-pedestrian (V2P) communications, vehicle-to-infrastructure (V21) communications, and vehicle-to-network (V2N) communications. V2X WTRUs may engage in V2X communications.

### SUMMARY

A remote wireless transmit/receive unit (WTRU) may receive, from a serving base station, configuration information including triggering conditions for a measurement event. Further, the remote WTRU may receive from the serving base station, one or more offset values to apply to Uu radio quality measurements, wherein each offset value corresponds to a value or range of values of sidelink (SL) channel busy ratio (CBR)/channel occupation ratio (CR) radio quality, SL radio quality or both. Also, the remote WTRU may measure Uu radio quality. Moreover, the remote WTRU may measure SL CBR/CR radio quality, SL radio quality, or both. Additionally, the remote WTRU may apply an offset to the measured Uu radio quality, wherein the applied offset is determined based on an offset value, of the received one or more offset values, that corresponds with the measured SL CBR/CR radio quality, SL radio quality or both. On a condition that the measurement event is triggered based on the received triggering conditions, the remote WTRU may transmit an indication including the applied offset.

In a further example, the remote WTRU may transmit a measurement report to the serving base station based on the triggering of the measurement event. Also, the measurement event may be associated with measurement reporting. Further, the indication including the applied offset may be transmitted in the measurement report.

In a further example, the remote WTRU may execute a conditional handover (CHO), from the serving base station to a neighbor base station, based on the triggering of the measurement event. In an example, the measurement event may be associated with CHO. Also, the remote WTRU may transmit, to the neighbor base station, the indication including the applied offset. Additionally, the applied offset may be further determined based on the received configuration information. In another example, the configuration information may include one or more of a measurement configuration, a CHO configuration, a measurement reporting configuration, a measurement event configuration, or a reporting configuration.

In an additional example, the triggering conditions may include a condition that the measured SL CBR/CR is below a first threshold. In a further example, the triggering conditions may include a condition that the measured SL CBR/CR is equal to or above a first threshold. In yet another example, the triggering conditions may include a condition that the measured SL radio quality is below a second threshold. In yet an additional example, the triggering conditions include a condition that the measured SL radio quality is equal to or above a second threshold. In yet a further example, the triggering conditions may include a condition that the measured Uu radio quality is below a third threshold. Additionally or alternatively, the triggering conditions include a condition that the measured Uu radio quality is equal to or above a third threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a protocol stack diagram illustrating an example of a user plane protocol stack for a layer 2 (L2) WTRU-to-network relay;

FIG. 3 is a protocol stack diagram illustrating an example of a control plane protocol stack for an L2 WTRU-to-network relay;

FIG. 4 is a protocol stack diagram illustrating an example of a protocol view of a split bearer;

FIG. 5 is a protocol stack diagram illustrating an example of a protocol view of a split bearer configured with a single packet data convergence protocol (PDCP) entity and associated with two different radio link control (RLC) entities;

FIG. 6 is a system diagram illustrating an example of wireless communication scenario that includes a relay WTRU and remote WTRU;

FIG. 7 is a system diagram illustrating an example of wireless communication, including a remote WTRU applying sidelink (SL) conditions to an offsets mapping;

FIG. 8 is a flowchart diagram illustrating an example of wireless communication, including a remote WTRU applying SL conditions to an offsets mapping; and

FIG. 9 is another flowchart diagram illustrating an example of wireless communication, including a remote WTRU applying SL conditions to an offsets mapping.

### DETAILED DESCRIPTION

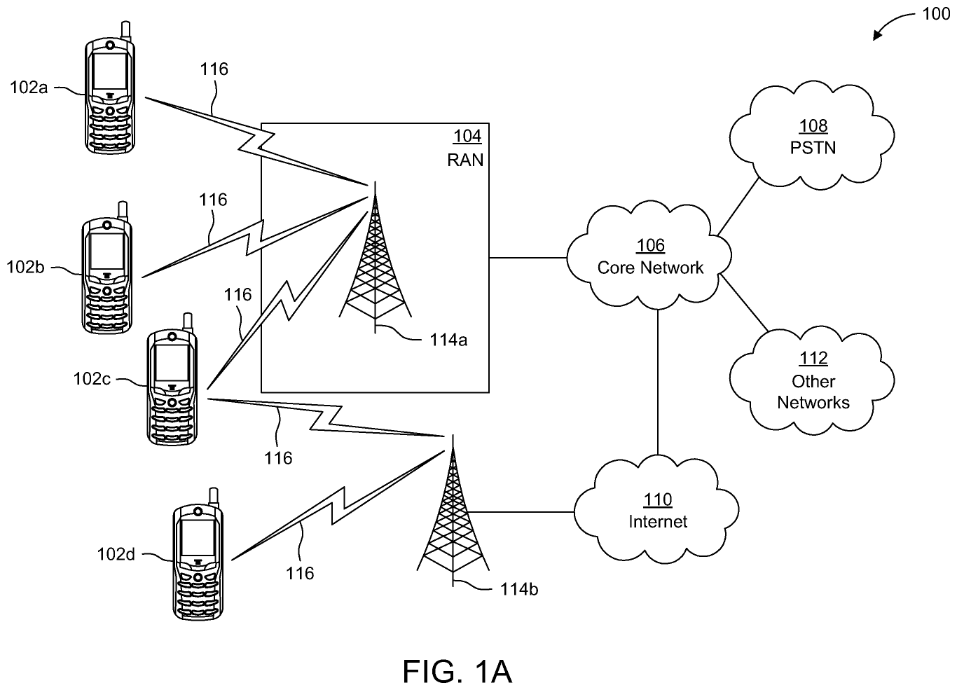

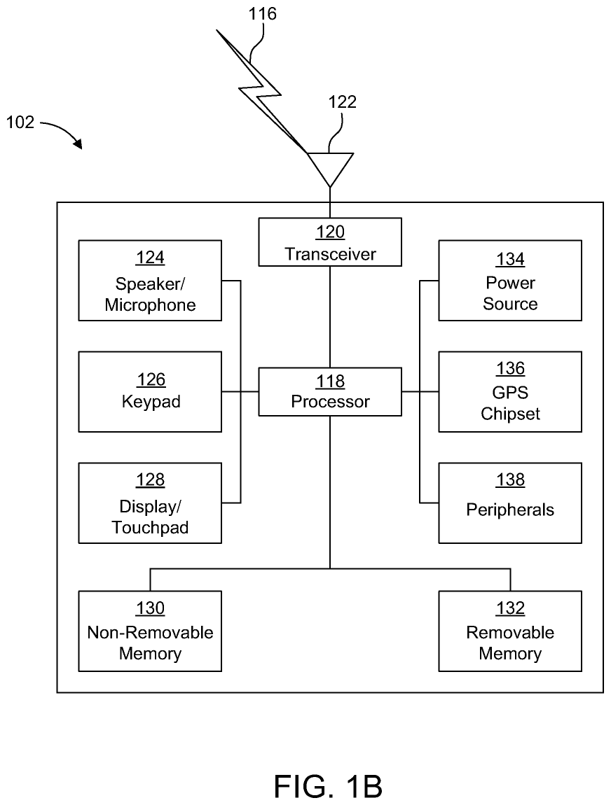

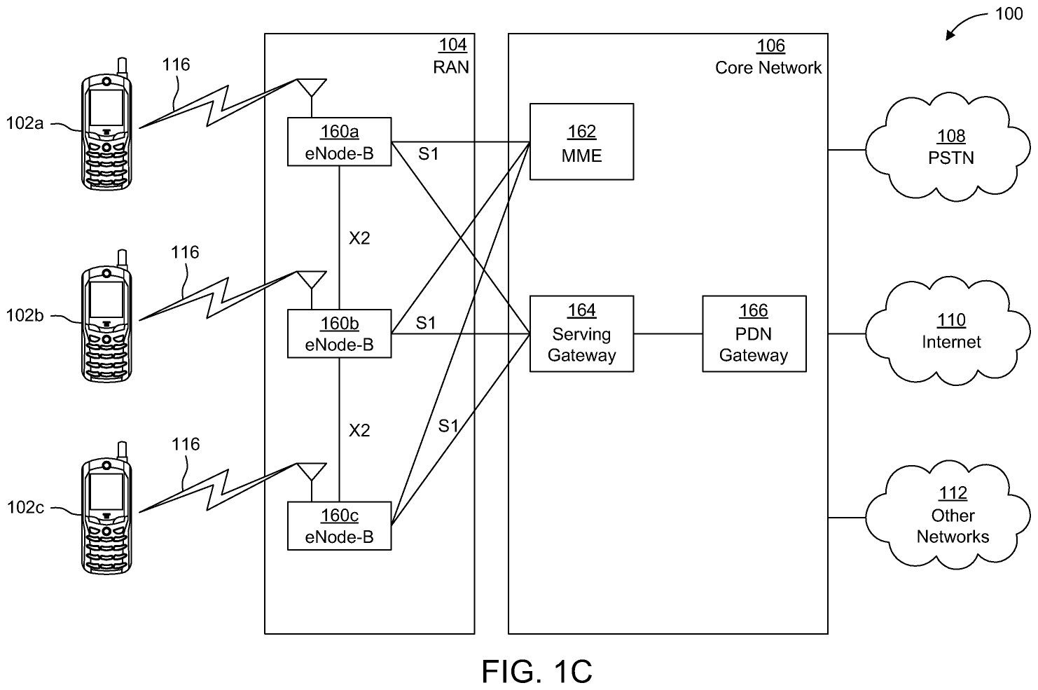

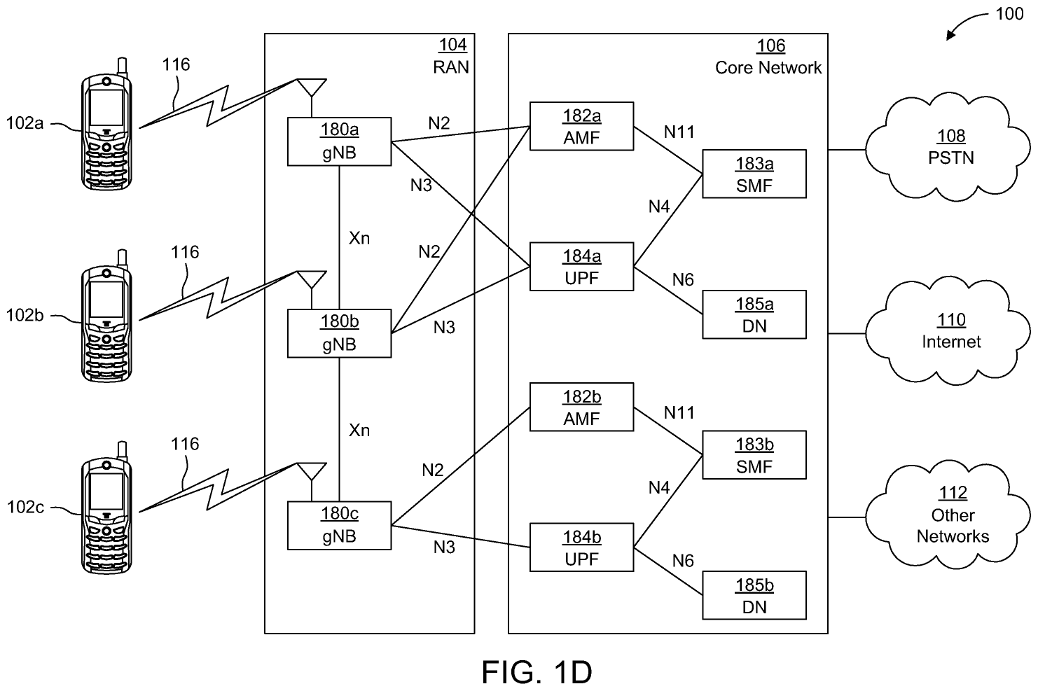

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In wireless communication, relaying via a WTRU to one or more network relays has been known to extend network coverage to an out of coverage WTRU using a PC5 interface between the out of coverage WTRU and a WTRU-to-network relay. In an example, the WTRU may be a ProSe WTRU. In a further example, the one or more network relays may be one or more network relay nodes. Also, the PC5 interface may be used for D2D communication, in an example.

A ProSe WTRU-to-Network Relay provides a generic layer 3 (L3) forwarding function that can relay any type of IP traffic between the remote WTRU and the network. One-to-one and one-to-many sidelink communications are used between the remote WTRU(s) and the ProSe WTRU-to-Network relay. For both remote WTRU and relay WTRU only one single carrier, such as a Public Safety ProSe Carrier, operation is supported. For example, Uu and PC5 should be carried on the same carrier for the relay/remote WTRU. The remote WTRU is authorized by upper layers and can be in-coverage of the Public Safety ProSe Carrier or out-of-coverage on any supported carriers, including a Public Safety ProSe Carrier for WTRU-to-Network Relay discovery, (re)selection and communication. In examples, the ProSe WTRU-to-Network Relay is always in-coverage of an E-UTRA network (E-UTRAN).

A first version of NR sidelink has been developed and it solely focuses on supporting vehicle-to-everything (V2X) related road safety services. The design aims to provide support for broadcast, groupcast and unicast communications in both out-of-coverage and in-network coverage scenarios. On top of that, sidelink-based relaying functionality should be additionally studied in order for sidelink/network coverage extension and power efficiency improvement, considering wider range of applications and services.

To further explore coverage extension for sidelink-based communication, a WTRU-to-network coverage extension is being developed. Uu interface coverage reachability is necessary for WTRUs to reach a server in a PDN network or counterpart WTRU out of proximity area. However, current solutions on WTRU-to-network relay are limited to EUTRA-based technology, and thus may not be applied to NR-based system, for both NG-RAN and NR-based sidelink communication.

Also, to further explore coverage extension for sidelink-based communication, a WTRU-to-WTRU coverage extension is being developed. Currently proximity reachability is limited to single-hop sidelink link, either via EUTRA-based or NR-based sidelink technology. However, that is not sufficient in the scenario where there is no Uu coverage, considering the limited single-hop sidelink coverage.

Sidelink connectivity was further extended in an NR framework. Such an extension includes support for enhanced QoS requirements.

Recent developments introduced single hop NR sidelink relays with the following main objectives. A minimum service or specification impact to support the design requirements for sidelink-based WTRU-to-network and WTRU-to-WTRU relay, focusing on the following aspects (if applicable) for layer-3 relay and layer-2 relay include one or more of: relay (re-)selection criterion and procedure; relay/remote WTRU authorization; QoS for relaying functionality; service continuity; or security of a relayed connection. Further study is being done to support upper layer operations of a discovery model/procedure for sidelink relaying, assuming no new physical layer channel/signal.

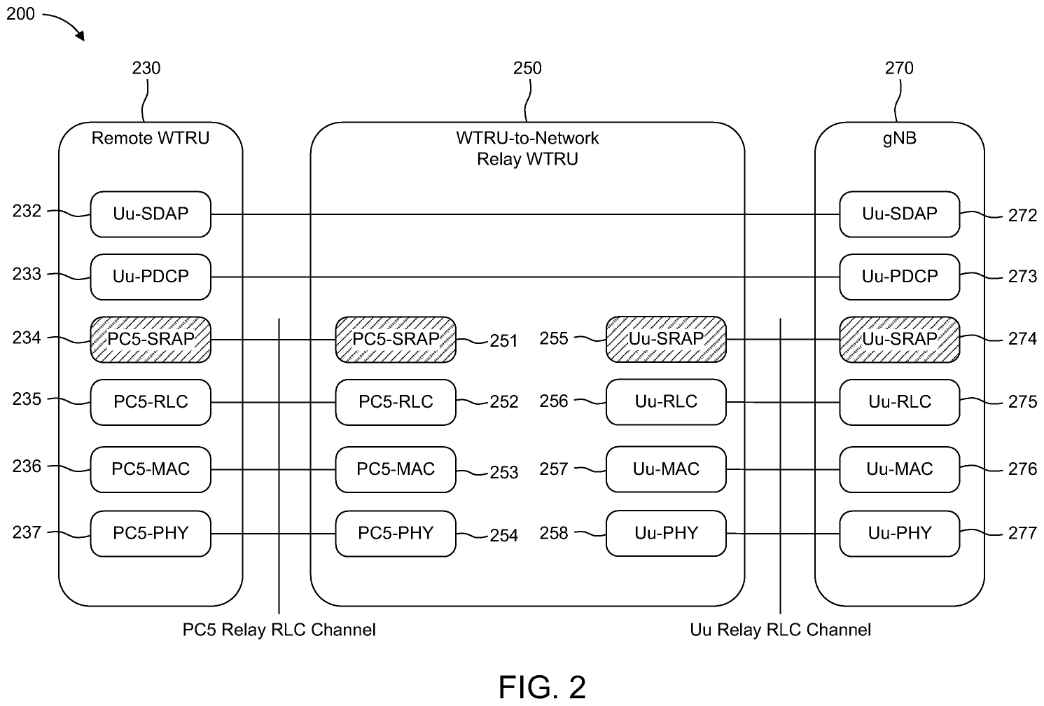

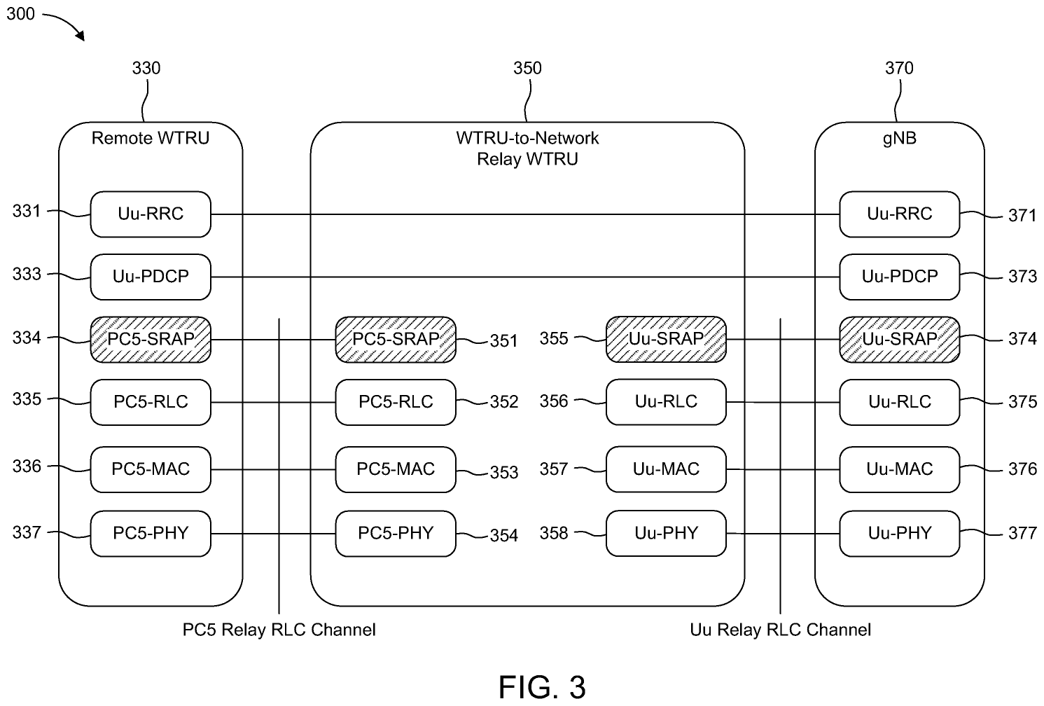

FIG. 2 is a protocol stack diagram illustrating an example of a user plane protocol stack for an L2 WTRU-to-network relay. FIG. 3 is a protocol stack diagram illustrating an example of a control plane protocol stack for an L2 WTRU-to-network relay. The protocol stacks for the user plane and control plane of L2 user equipment-to-network (U2N) relay, or WTRU-to-network relay, architecture are presented in FIG. 2 and FIG. 3.

As shown in an example in protocol stack diagram 200, the sidelink relay adaptation protocol (SRAP) layer is placed above the radio link control (RLC) layer for both the control plane (CP) and user plane (UP) at both the PC5 interface and Uu interface. For example, as shown in an example in protocol stack diagram 200 for the UP, PC5-SRAP layer 234 is placed above PC5-RLC layer 235 at remote WTRU 230, and PC5-SRAP layer 251 is placed above PC5-RLC layer 252 at WTRU-to-Network relay WTRU 250. Similarly, Uu-SRAP layer 274 is placed above Uu-RLC layer 275 at gNB 270, and Uu-SRAP layer 255 is placed above Uu-RLC layer 256 at WTRU-to-Network relay WTRU 250. In an example, the gNB may be a base station.

In a similar example shown in protocol stack diagram 300 for the CP, PC5-SRAP layer 334 is placed above PC5-RLC layer 335 at remote WTRU 330, and PC5-SRAP layer 351 is placed above PC5-RLC layer 352 at WTRU-to-Network relay WTRU 350. Likewise, Uu-SRAP layer 374 is placed above Uu-RLC layer 375 at gNB 370, and Uu-SRAP layer 355 is placed above Uu-RLC layer 356 at WTRU-to-Network relay WTRU 350.

The Uu service data adaptation protocol (SDAP) layer, packet data convergence protocol (PDCP) layer and radio resource control (RRC) layer are terminated between an L2 U2N remote WTRU and gNB, while SRAP layer, RLC layer, MAC layer and physical (PHY) layers are terminated in each respective hop, for example, the link between the L2 U2N remote WTRU and L2 U2N relay WTRU and the link between the L2 U2N relay WTRU and the gNB.

For example, as shown in protocol stack diagram 200 for the UP, Uu-SDAP layer 232 is terminated at remote WTRU 230, and Uu-SDAP layer 272 is terminated at gNB 270. Also, Uu-PDCP layer 233 is terminated at remote WTRU 230, and Uu-PDCP layer 273 is terminated at gNB 270. Similarly, as shown in protocol stack diagram 300 for the CP, Uu-RRC layer 331 is terminated at remote WTRU 330, and Uu-RRC layer 371 is terminated at gNB 370. Further, Uu-PDCP layer 333 is terminated at remote WTRU 330, and Uu-PDCP layer 373 is terminated at gNB 370.

In comparison, as shown in an example in protocol stack diagram 200 for the UP, PC5-SRAP layer 234, PC5-RLC layer 235, PC5-MAC layer 236 and PC5-PHY layer 237 may terminate at remote WTRU 230, and PC5-SRAP layer 251, PC5-RLC layer 252, PC5-MAC layer 253 and PC5-PHY layer 254 may terminate at WTRU-to-Network relay WTRU 250. Similarly, Uu-SRAP layer 255, Uu-RLC layer 256, Uu-MAC layer 257 and Uu-PHY layer 258 may terminate at WTRU-to-Network relay WTRU 250, and Uu-SRAP layer 274, Uu-RLC layer 275, Uu-MAC layer 276 and Uu-PHY layer 277 may terminate at gNB 270.

Likewise, as shown in an example in protocol stack diagram 300 for the CP, PC5-SRAP layer 334, PC5-RLC layer 335, PC5-MAC layer 336 and PC5-PHY layer 337 may terminate at remote WTRU 330, and PC5-SRAP layer 351, PC5-RLC layer 352, PC5-MAC layer 353 and PC5-PHY layer 354 may terminate at WTRU-to-Network relay WTRU 350. In a similar way, Uu-SRAP layer 355, Uu-RLC layer 356, Uu-MAC layer 357 and Uu-PHY layer 358 may terminate at WTRU-to-Network relay WTRU 250, and Uu-SRAP layer 374, Uu-RLC layer 375, Uu-MAC layer 376 and Uu-PHY layer 377 may terminate at gNB 370.

For an L2 U2N relay, the SRAP sublayer over a PC5 hop is only for the purpose of bearer mapping. The SRAP sublayer is not present over the PC5 hop for relaying the L2 U2N remote WTRU's messages on a broadcast control channel (BCCH) and paging control channel (PCCH). For an L2 U2N remote WTRU's message on signaling radio bearer (SRB) 0 (SRB0), the SRAP sublayer is not present over the PC5 hop, but the SRAP sublayer is present over the Uu hop for both DL and UL.

For the L2 U2N relay, for uplink, the Uu SRAP sublayer supports UL bearer mapping between ingress PC5 Relay RLC channels for relaying and egress Uu Relay RLC channels over the L2 U2N Relay WTRU Uu interface. For uplink relaying traffic, the different end-to-end radio bearers (RBs), such as SRBs or data radio bearers (DRBs), of the same remote WTRU and/or different remote WTRUs can be multiplexed over the same Uu Relay RLC channel.

Further for the L2 U2N relay, for uplink, the Uu SRAP sublayer supports L2 U2N Remote WTRU identification for the UL traffic. The identity information of L2 U2N Remote WTRU Uu Radio Bearer and a local Remote WTRU ID are included in the Uu SRAP header at UL in order for gNB to correlate the received packets for the specific PDCP entity associated with the right Uu Radio Bearer of a Remote WTRU. Also, the PC5 SRAP sublayer at the L2 U2N Remote WTRU supports UL bearer mapping between Remote WTRU Uu Radio Bearers and egress PC5 Relay RLC channels.

For the L2 U2N relay, for downlink, the Uu SRAP sublayer supports DL bearer mapping at the gNB to map end-to-end Radio Bearer, such as an SRB or DRB, of a remote WTRU into Uu Relay RLC channel over relay WTRU Uu interface. The Uu SRAP sublayer supports DL bearer mapping and data multiplexing between multiple end-to-end Radio Bearers (SRBs or DRBs) of a L2 U2N Remote WTRU and/or different L2 U2N Remote WTRUs and one Uu Relay RLC channel over the Relay WTRU Uu interface.

Further for the L2 U2N relay, for downlink, the Uu SRAP sublayer supports Remote WTRU identification for DL traffic. The identity information of Remote WTRU Uu Radio Bearer and a local Remote WTRU ID are included into the Uu SRAP header by the gNB at DL in order for Relay WTRU to map the received packets from Remote WTRU Uu Radio Bearer to its associated PC5 Relay RLC channel.

Also, for the L2 U2N relay, for downlink, the PC5 SRAP sublayer at the Relay WTRU supports DL bearer mapping between ingress Uu Relay RLC channels and egress PC5 Relay RLC channels. The PC5 SRAP sublayer at the Remote WTRU correlates the received packets for the specific PDCP entity associated with the right Uu Radio Bearer of a Remote WTRU based on the identity information included in the Uu SRAP header.

A local remote WTRU identity (ID) is included in both a PC5 SRAP header and a Uu SRAP header. L2 U2N Relay WTRU is configured by the gNB with the local Remote WTRU ID to be used in an SRAP header. Remote WTRU obtains the local Remote ID from the gNB via Uu RRC messages including RRCSetup, RRCReconfiguration, RRCResume and RRCReestablishment. Uu DRB(s) and Uu SRB(s) are mapped to different PC5 Relay RLC channels and Uu Relay RLC channels in both PC5 hop and Uu hop.

The base station, or gNB, has the responsibility of avoiding collision on the usage of local Remote WTRU ID. The gNB can update the local Remote WTRU ID by sending the updated local Remote ID via RRCReconfiguration message to the Relay WTRU. The serving gNB can perform local Remote WTRU ID update independent of the PC5 unicast link L2 ID update procedure.

Examples and embodiments provided herein describe multipath operation with sidelink (SL) relay in NR. The current NR SL relay procedures may benefit from further enhancements and modifications. One area of enhancement includes the support of multi-path with relay, where a remote WTRU is connected to network via direct and indirect paths, and this area has a potential to improve the reliability/robustness as well as throughput.

The multi-path relay solution can also be utilized for WTRU aggregation where a WTRU is connected to the network via direct path and via another WTRU using a non-standardized WTRU-WTRU interconnection. WTRU aggregation aims to provide applications requiring high UL bitrates on 5G terminals, in cases when normal WTRUs are too limited by UL WTRU transmission power to achieve a required bitrate, especially at the edge of a cell. Additionally, WTRU aggregation can improve the reliability, stability and reduce delay of services as well. That is, if the channel condition of a terminal is deteriorating, another terminal can be used to make up for the traffic performance unsteadiness caused by channel condition variation. Multipath operation is a core area of enhancements and modifications.

Examples and embodiments provided herein include the benefit of and potential solutions for multi-path support to enhance reliability and throughput, for example, by switching among or utilizing the multiple paths simultaneously, in the following scenarios. In an example, a WTRU may be connected to the same gNB using one direct path and one indirect path via: 1) a Layer-2 WTRU-to-Network relay, or 2) another WTRU, where the WTRU-WTRU inter-connection is assumed to be ideal. Further, the solutions for 1) are to be reused for 2) without precluding the possibility of excluding a part of the solutions which is unnecessary for the operation for 2). Enhancements and modifications may be made based on this multi-path support.

Examples and embodiments provided herein describe sidelink measurements and scheduling. In SL operation, the WTRU may configure the associated peer WTRU to perform NR sidelink measurement and report on the corresponding PC5-RRC connection in accordance with the NR sidelink measurement configuration for unicast included in an RRCReconfigurationSidelink message. Further, a WTRU shall derive NR sidelink measurement results by measuring one or multiple demodulation reference signals (DMRSs) associated per PC5-RRC connection as configured by the associated peer WTRU. For all NR sidelink measurement results, the WTRU applies layer 3 filtering before using the measured results for evaluation of reporting criteria and measurement reporting. In prior approaches, only NR sidelink reference signal received power (RSRP) can be configured as trigger quantity and reporting quantity.

The following measurement events are defined for NR sidelink: Event S1 (serving becomes better than a threshold); and Event S2 (serving becomes worse than the threshold). The S1 and S2 based measurement(s), and measurement reports, are used by the WTRU receiving the report to adjust the power level when transmitting data.

NR sidelink transmissions have the following two modes of resource allocations: Mode 1 where sidelink resources are scheduled by a base station, such as a gNB; and Mode 2 where the WTRU autonomously selects sidelink resources from one or more preconfigured or configured sidelink resource pools based on the channel sensing mechanism. For the in-coverage WTRU, WTRUs can be configured to operate in Mode 1 or Mode 2. For the out-of-coverage WTRU, only Mode 2 can be adopted in current NR operation.

To enhance a QoS of NR sidelink transmissions, congestion control is important, especially in Mode 2, to prevent a transmitting WTRU from occupying too many resources in sidelink transmissions. Two metrices are defined for this purpose: channel busy ratio (CBR) and channel occupation ratio (CR). The CBR is defined as the portion of subchannels whose received signal strength indicator (RSSI) exceeds a preconfigured value over a certain time duration. Considering a particular slot n, the CR is defined as (X+Y)M, where X is the number of the subchannels that have been occupied by a transmitting WTRU within [n−a, n−1], Y is the number of the subchannels that have been granted within [n, n+b], and M is the total number of subchannels within [n−a, n+b].

For congestion control, an upper bound of CR denoted by CRₗᵢₘᵢₜ is imposed to a transmitting WTRU, where CRₗᵢₘᵢₜ is a function of CBR and the priority of the sidelink transmissions. The amount of resources occupied by a transmitting WTRU may not exceed CRₗᵢₘᵢₜ. The CBR report is also used by the gNB to determine the pool of resources allocated to sidelink communication. For example, the CBR report may be used to increase the pool of resources if the WTRUs involved in sidelink communication are reporting high CBRs, decrease the pool of resources if the CBRs reported are low, and the like.

In addition to peer WTRUs involved in sidelink operation configuring each other for measurement, either periodical or S1/S2 events, for in coverage operation, where the remote WTRU is within the coverage of the gNB, the gNB can configure the remote WTRU with CBR measurements, which can also be either periodical or event triggered. The following two measurement events can be configured for CBR measurement reporting: Event C1, where a CBR of NR sidelink communication becomes better than an absolute threshold; and Event C2, where the CBR of NR sidelink communication becomes worse than the absolute threshold.

Examples and embodiments provided herein describe measurements on the Uu interface. In RRC_CONNECTED mode, the WTRU measures one or multiple beams of a cell and the measurement results, such as power values, are averaged to derive the cell quality. In doing so, the WTRU is configured to consider a subset of the detected beams. Filtering takes place at two different levels: at the physical layer to derive beam quality, and then at the RRC level to derive cell quality from multiple beams. Cell quality from beam measurements is derived in the same way for the serving cell(s) and for the non-serving cell(s). Measurement reports may contain the measurement results of the X best beams if the WTRU is configured to do so by the gNB.

Measurement reports are characterized by the following. Measurement reports include the measurement identity of the associated measurement configuration that triggered the reporting. Further, cell and beam measurement quantities to be included in measurement reports are configured by the network. Also, the number of non-serving cells to be reported can be limited through configuration by the network. Cells belonging to a blacklist configured by the network are not used in event evaluation and reporting, and conversely when a whitelist is configured by the network, only the cells belonging to the whitelist are used in event evaluation and reporting. Moreover, beam measurements to be included in measurement reports are configured by the network. For example, the network transmit configuration information to indicate that one or more of the following may be included in measurement reports: beam identifier only, measurement result and beam identifier, or no beam reporting.

The measurement reporting configuration can be either event triggered or periodical. If it is periodical, the WTRU sends the measurement report every reporting interval. In examples, the reporting interval may range between 120 ms and 30 min.

For event triggered measurements, the WTRU sends the measurement report when the conditions associated with the event are fulfilled. The WTRU keeps on measuring serving cell and neighbors report quantity and validate it with the threshold or offset defined in the measurement report configuration. The report quantity/the trigger for event can be RSRP, reference signal received quality (RSRQ) or signal-to-interference-plus-noise ratio (SINR).

The following measurement events are defined for NR, including intra-RAT events and inter-RAT events. Intra-RAT events include Event A1 through Event A6. Event A1 is triggered when a serving cell becomes better than a threshold and is typically used to cancel an ongoing handover procedure. This may be required if a WTRU moves towards a cell edge and triggers a mobility procedure, but then the WTRU subsequently moves back into good coverage before the mobility procedure has completed.

Event A2 is triggered when a serving cell becomes worse than a threshold. Since it does not involve any neighbor cell measurements, A2 is typically used to trigger a blind mobility procedure, or the network may configure the WTRU for neighbor cell measurements when it receives a measurement report that is triggered due to event A2 in order to save WTRU battery life. In an example, the WTRU may not perform neighbor cell measurement when the serving cell quality is good enough.

Event A3 is triggered when a neighbor becomes better than a special cell (SpCell) by an offset. Event A3 is typically used for handover procedures. Note that an Spcell is the primary serving cell of either the Master Cell Group (MCG), i.e. the PCell, or Secondary Cell Group (SCG), i.e. the PSCell. Thus, in DC operation, the Secondary Node (SN) can configure an A3 event for SN triggered PSCell change.

Event A4 is triggered when a neighbor cell becomes better than a threshold. Typically, Event A4 is used for handover procedures which do not depend upon the coverage of the serving cell. For example, Event A4 may be used for load balancing, where the WTRU is handed over to a good neighbor cell even if the serving cell conditions are excellent.

Event A5 is triggered when an SpCell becomes worse than threshold1 and a neighbor cell becomes better than threshold2. As in Event A3, this is typically used for handover, but unlike Event A3, Event A5 provides a handover triggering mechanism based upon absolute measurements of the serving and neighbor cell, while Event A3 uses a relative comparison. As such, Event A5 is suitable for time critical handover when the serving cell becomes weak and it is necessary to change towards another cell which may not satisfy the criteria for an Event A3 handover.

Event A6 is triggered when a neighbor cell becomes offset better than SCell. This approach is used for adding or releasing SCells.

Inter-RAT events include Event B1 and Event B2. Event B1 includes an inter-RAT neighbor cell that becomes better than a threshold. This example is equivalent to Event A4, above, but for the case of inter-RAT handover.

Event B2 includes a PCell that becomes worse than threshold1 and an inter-RAT neighbor cell becomes better than threshold2. This example is equivalent to Event A6, but for the case of inter-RAT handover.

The WTRU's measurement configuration can contain an s-measure configuration, such as an s-MeasureConfig, which specifies a threshold for NR SpCell RSRP measurement controlling when the WTRU is required to perform measurements on non-serving cells. That is, when the serving cell's RSRP, such as the PCell's RSRP, is above the s-measure threshold, the WTRU is not required to perform neighbor cell measurements, thereby saving WTRU battery power, battery life or both.

Examples and embodiments provided herein describe split bearers in DC. In DC, a WTRU is being served by two nodes, each comprising a set of cells, known as the MCG and SCG. A bearer can be associated only with the MCG or with the SCG, or it can be configured to be a split bearer.

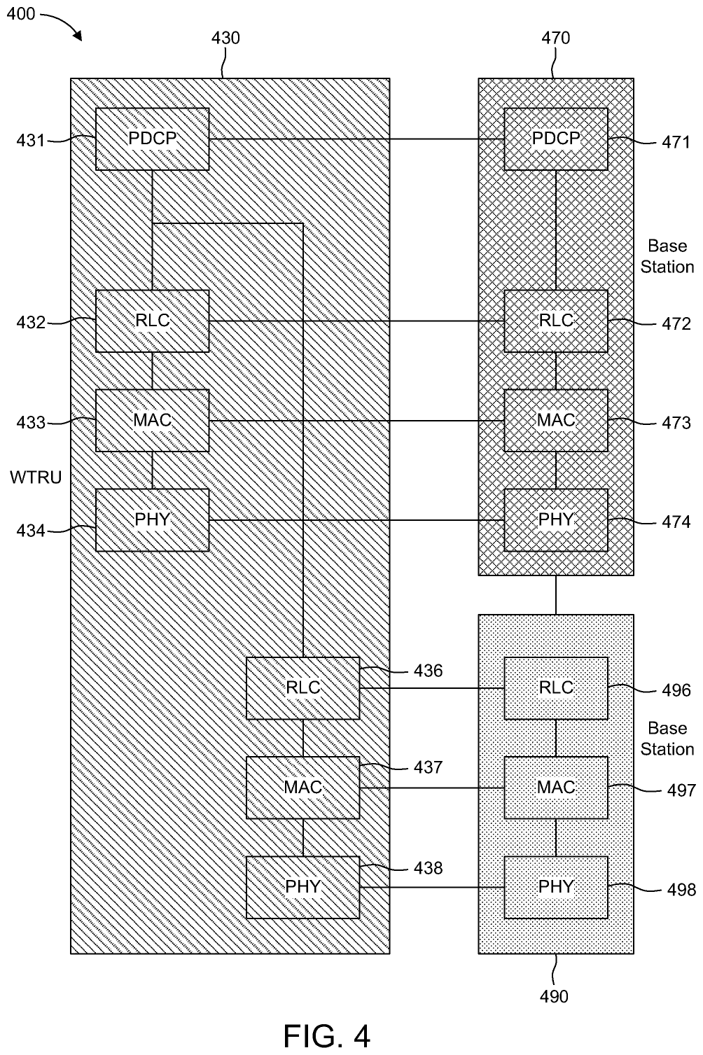

FIG. 4 is a protocol stack diagram illustrating an example of a protocol view of a split bearer. As shown in an example in protocol stack diagram 400, WTRU 430 may be served by base station 470 and base station 490. As with any bearer, the WTRU will have one PDCP entity 431 associated with it, and the peer PDCP entity on the network side is terminated either at one of the base stations, either the master base station or the secondary base station. In the DL, the CN sends the data to the base station where the PDCP is terminated, base station 470 with PDCP entity 471, and it is up to the network to directly send the data to the WTRU 430 via the link between the base station 470 and the WTRU 430. Additionally or alternatively, the base station 470 may forward the PDCP PDUs to the base station 490, via the Xn interface in an example, and the base station 490 will send the data to the WTRU 430 via the link between the base station 490 and the WTRU 430. In an example, the base stations may be gNBs.

In the UL, the WTRU is configured with one of the paths as the primary path, and the other as a secondary path. A threshold, known as UL split buffer threshold is also configured. If the UL buffer size for that bearer is less this threshold, the PDCP will push the data only to the RLC associated with the primary path. For example, PDCP entity 431 may push the data to RLC entity 432, and the data may continue on the primary path to RLC entity 472 in base station 470. However, if the buffer size becomes larger than the threshold, then the WTRU 430 can push the data to either path. For example, PDCP entity 431 may push the data to RLC entity 436, and the data may continue on the secondary path to RLC entity 496 in base station 490. Such a push of data to either path can be performed in several different ways.

Further, in an example shown in FIG. 4, MAC entity 433 in WTRU 430 may be operatively coupled to MAC entity 473 in base station 470, and PHY entity 434 in WTRU 430 may be operatively coupled to PHY entity 474 in base station 470. Moreover, MAC entity 437 in WTRU 430 may be operatively coupled to MAC entity 497 in base station 490, and PHY entity 438 in WTRU 430 may be operatively coupled to PHY entity 498 in base station 490.

SL to network (NW) relays in current solutions focus on the out of coverage (OOC) remote WTRU. As discussed above, recent enhancements and modifications on SL relay will cover the case for a remote WTRU operating in multipath when in coverage. For example, the WTRU may have available one path over direct Uu, and another path via the SL WTRU to NW relay. This allows for more flexible use of both relayed and non-relayed paths by a remote WTRU.

Multipath can be modelled similarly to dual connectivity from a protocol architecture perspective. For example, at the remote WTRU, a split bearer can be configured with a single PDCP entity and associated with two different RLC entities, one associated with Uu and another associated with SL. In an example, multipath may include one path via Uu and another path via relay.

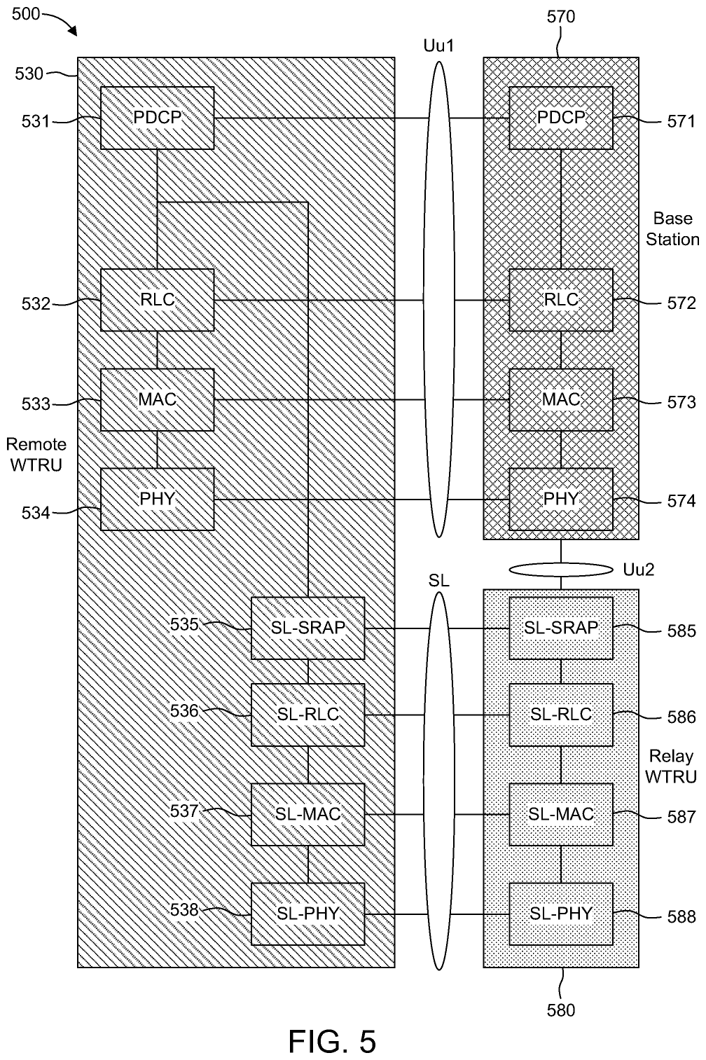

FIG. 5 is a protocol stack diagram illustrating an example of a protocol view of a split bearer configured with a PDCP entity and associated with two different RLC entities. In an example shown in protocol stack diagram 500, in remote WTRU 530, one RLC entity 532 is associated with Uu and another RLC entity 536 is associated with SL. The common PDCP entity 531 can therefore route data to either RLC entity, much like in dual connectivity. For example, the remote WTRU 530 may use the common PDCP entity 531 to route data using a primary path until the UL buffer for that bearer is below a split buffer threshold associated with that bearer, and route data using either path otherwise.

In an example, one path may be for the remote WTRU 530 to use the common PDCP entity 531 to route data to RLC entity 532, and then use the Uu1 link to route the data further on to RLC entity 572 in base station 570. Also, another path may be for the remote WTRU 530 to use the common PDCP entity 531 to route data to RLC entity 536, and then use the SL link to route the data further on to SL-RLC entity 586 in relay WTRU 580.

Moreover, in an example shown in FIG. 5, MAC entity 533 in remote WTRU 430 may be operatively coupled to MAC entity 573 in base station 570, and PHY entity 534 in remote WTRU 530 may be operatively coupled to PHY entity 574 in base station 570. Base station 570 may further include PDCP entity 571, which may be operatively coupled to PDCP 531 in remote WTRU 530. Further, SL-SRAP entity 535 in remote WTRU 530 may be operatively coupled to SL-SRAP entity 585 in relay WTRU 580. Moreover, SL-MAC entity 537 in remote WTRU 530 may be operatively coupled to SL-MAC entity 587 in relay WTRU 580, and SL-PHY entity 538 in remote WTRU 530 may be operatively coupled to SL-PHY entity 588 in relay WTRU 580.

On the other hand, if the same base station or gNB is serving the cells of the Uu and the SL, then one may consider this to be similar to the case of carrier aggregation (CA). However, in CA, one MAC entity is utilized, which is not really the case shown above, as a separate SL-MAC entity is used for the SL, such as SL-MAC entity 537 and SL-MAC entity 587. And to complicate things even further, the Uu and the SL may be served by the same cell of a given base station or gNB, in other words not using CA.

In current NR, whether it is CA or DC operation, A and B events are related to one specific serving cell or neighbor cell. In examples using A and B events, the WTRU may make a comparison of the serving cell with a neighbor cell. In Multipath operation with SL relay, specifically when both the Uu and SL are being served by the same cell, the current serving link/cell is not just the Uu or the SL, but rather a combination of the two. If only the Uu link's quality is considered in making handover decisions, for example, compared via an A3 event that compared the serving Uu quality with a neighbor Uu quality, it is possible that the WTRU's performance can degrade, for example, if the SL was in excellent radio conditions and the CBR/CR was low.

Therefore, solutions are provided in examples and embodiments herein regarding, when a remote WTRU is connected in a multipath fashion with a Uu and SL that are being served by the same base station cell, how to consider the two links together for measurements and associated procedures. In an example, the base station may be a gNB. In further examples, the measurements and associated procedures may include measurement reporting, handover (HO), conditional handover (CHO), and the like.

The solutions provided in examples and embodiments herein are mainly targeted to a scenario where a remote WTRU is connected via a direct link and a relayed link, such as via an SL relay, to the same base station. However, without loss of generality, the solutions are applicable to other scenarios such as multihop scenarios, for example, where the relay WTRU is further connected to a parent relay WTRU which is connected to the base station. In an example, the base station may be a gNB.

In the descriptions of the example solutions provided herein, for the sake of brevity, we have focused on measurement reporting triggering conditions. However, the solutions are equally applicable to the case of CHO, as CHO is also triggered based on measurement configurations that have associated trigger conditions and prepared HO commands to execute when the trigger conditions are fulfilled.

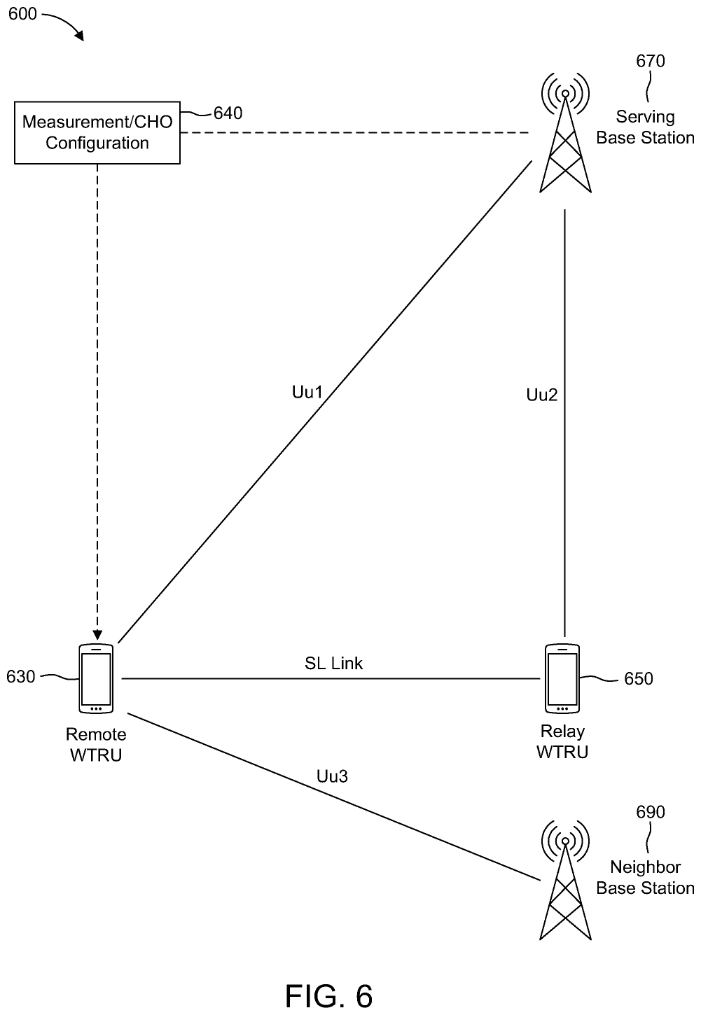

FIG. 6 is a system diagram illustrating an example of wireless communication including a relay WTRU and a remote WTRU. The terms Uu and direct link are used interchangeably throughout the examples and embodiments provided herein. When referring to the Uu link in the example solutions, the reference may be meant to the Uu1 link between the serving base station 670, such as a gNB, and the remote WTRU 630 shown in examples in system diagram 600.

In examples shown in FIG. 6, serving base station 670 may send configuration information 640 to remote WTRU 630. The configuration information 640 may be or may include one or more of a measurement configuration, a reporting configuration, a measurement report configuration, a measurement reporting configuration, a CHO configuration, and the like. Further, serving base station 670 may also be connected to relay WTRU 650 via a Uu2 link. Remote WTRU 630 may be connected to relay WTRU 650 via an SL link. Moreover, relay WTRU 650 may be connected to a neighbor base station 690 via a Uu3 link.

Examples and embodiments provided herein include the following solutions. A WTRU may be configured to add an offset value on the serving Uu measurements that is dependent on the SL CBR/CR. Also, a WTRU may be configured to add an offset value on the serving Uu measurements that is dependent on the SL radio quality. Further, a WTRU may be configured to add, to modify, or both, the CBR/CR reporting thresholds for C1/C2 events, depending on the Uu radio quality. In addition, a WTRU may be configured to modify the s-measure threshold for the Uu based on SL CBR/CR. Moreover, a WTRU may be configured to modify the s-measure threshold for the Uu based on SL radio quality. Moreover, a WTRU may be configured to modify the s-measure threshold for the SL based on Uu radio quality. Additionally, a WTRU may be configured to consider the QoS and buffer levels of the active bearers on determining the offsets and s-measure thresholds. Further, a WTRU may be configured to consider the RRC state of the relay WTRU. For example, a WTRU may apply different offsets for different RRC states, under the same Uu and SL radio and CBR conditions. In addition, a WTRU may be configured to start, or stop, adding an offset value on the serving Uu cell measurements when the WTRU performs cell re-selection away from, or towards, the serving Uu cell, respectively. Also, a WTRU may be configured to stop adding an offset value on the serving Uu cell measurements when the Uu radio signal level is below a certain threshold. Further, a WTRU may be configured to consider or reconsider CHO trigger conditions without the consideration of the offset due to the SL transmission added on top of the measured Uu quality, in case radio link failure (RLF) was detected over the Uu. Moreover, a WTRU may be configured with measurements or CHO configurations that consider both the Uu and the SL conditions.

In examples and embodiments provided herein, a remote WTRU may be configured with multipath operation via an SL relay and configured with measurement/CHO configurations, and further configured to apply different offsets, on top of serving cell measurements, corresponding to different values/ranges of SL CBR/CR and/or SL radio quality. In an example, the remote WTRU may apply different offsets when evaluating A/B events.

A remote WTRU, operating in a multipath setting towards a given base station (for example, a gNB), using a direct link (Uu) and a SL via a relay WTRU, may perform the following. The remote WTRU may receive a measurement/CHO configuration with triggering conditions. The triggering conditions may include, for example, an A3 event or a conditional A3 event that is triggered when one or more conditions of one or more neighbor cells become a threshold better than the serving cell. Also, the remote WTRU may receive a mapping of offset values to add on top of serving cell measurements, each offset value corresponding to a value or range of values of SL CBR/CR and/or SL radio quality. Further, the remote WTRU may monitor the Uu conditions and SL conditions. On determining the Uu and SL are being served by the same cell, the remote WTRU may consider the serving cell radio quality to be the measured Uu radio quality plus an offset, where the offset is the offset from the configuration that corresponds with the measured SL CBR/CR and/or SL radio quality. If measurement reporting or CHO is triggered, the remote WTRU may: send the measurement report, or execute the CHO; and/or send an indication to the network. In an example, the indication to the network may include the applied offset in a measurement report.

In examples and embodiments provided herein, a remote WTRU may be configured with multipath operation via an SL relay and configured with measurement/CHO configurations, and further configured to calculate the offset to be applied on top the serving cell measurements using a scaling factor/formula that is based on the SL CBR/CR and/or SL radio quality. In an example, the remote WTRU may apply the offset when evaluating A/B events.

A remote WTRU, operating in a multipath setting towards a given base station (for example, a gNB), using a direct link (Uu) and a SL via a relay WTRU, may perform the following. The remote WTRU may receive a measurement/CHO configuration with triggering conditions. The triggering conditions may include, for example, an A3 event or conditional A3 event that is triggered when neighbor cells becomes a threshold better than the serving cell. The remote WTRU may receive a baseline offset value to add on top of serving cell measurements, when the CBR is below a baseline CBR threshold and/or when the SL radio quality is above a certain baseline threshold. Also, the remote WTRU may receive a scaling factor/formula to modify the offset based on the comparison of the current CBR with the baseline CBR threshold and/or the current SL radio quality with the baseline SL quality threshold. In addition, the remote WTRU may monitor the Uu and SL conditions. On determining the Uu and SL are being served by the same cell, the remote WTRU may consider the serving cell radio quality to be the measured Uu radio quality plus an offset, where the offset is calculated according to the received configuration and the measured SL CBR/CR and/or SL radio quality. If measurement reporting or CHO is triggered, the remote WTRU may: send the measurement report, and/or execute the CHO; and/or send an indication to the network. In an example, the indication to the network may include the applied offset in a measurement report.

In examples and embodiments provided herein, a remote WTRU may be configured with multipath operation via an SL relay and configured with multiple s-measure thresholds used to determine when to start measuring neighbor cells, where the different s-measures are associated with different values/ranges of SL CBR/CR and/or SL radio quality. A remote WTRU, operating in a multipath setting towards a given base station (for example, a gNB), using a direct link (Uu) and a SL via a relay WTRU, may perform the following. The remote WTRU may receive multiple s-measure thresholds/values that correspond with a value or range of values of SL CBR/CR and/or SL radio quality. Also, the remote WTRU may monitor the Uu and SL conditions. On determining the Uu and SL are being served by the same cell, the remote WTRU may consider the s-measure to use to be the one corresponding with the measured SL CBR/CR and measured SL radio quality and the received s-measure configuration. If the measured Uu radio quality is below the determined s-measure, the remote WTRU may start performing neighbor measurements. If the measured Uu radio quality is above the determined s-measure, the remote WTRU may stop performing neighbor measurements.

In examples and embodiments provided herein, a remote WTRU may be configured to evaluate or reevaluate CHO trigger conditions without the consideration of the offset due to the SL on top of the measured Uu quality, in case RLF was detected over the Uu. A remote WTRU, operating in a multipath setting towards a given base station (for example, a gNB), using a direct link (Uu) and a sidelink (SL) via a relay WTRU, may perform the following. The remote WTRU may receive a CHO configuration with triggering conditions. The trigger conditions may include, for example, an A3 event or a conditional A3 event that is triggered when the signal level of a neighbor cell becomes better than the serving cell by more than a configured threshold. Also, the remote WTRU may receive a mapping of offset values to add on top of serving cell measurements, each offset value corresponding to a value or range of values of SL CBR/CR and/or SL radio quality. Further, the remote WTRU may monitor the Uu and SL conditions. Moreover, the remote WTRU may evaluate the CHO triggering conditions according to one or both of the following conditions. First, the remote WTRU may consider the measured Uu radio quality as the serving cell radio quality. Second, the remote WTRU may consider the serving cell radio quality to be the measured Uu radio quality plus an offset, where the offset is the offset from the configuration that corresponds with the measured SL CBR/CR and/or SL radio quality. If CHO conditions are fulfilled according to the first consideration, the remote WTRU may save the measured radio quality of the target cell, but does not execute the handover to the target. If CHO conditions are fulfilled according to the second consideration, the remote WTRU may execute the handover to the target.

Further, if an RLF is detected on the Uu, and the CHO conditions were earlier fulfilled according to the first condition, then the remote WTRU may compare the current radio quality of the concerned target with the saved radio quality of the target. If the current radio quality of the target is within a given threshold of the saved radio quality, the remote WTRU may execute the handover to the target. Otherwise, the remote WTRU may initiate the Uu re-establishment procedure. In an example of using the given threshold, the remote WTRU may determine if the current radio quality of the target is equal to or greater than a threshold of the saved radio quality. In another example of using the given threshold, the remote WTRU may determine if the current radio quality of the target is smaller than but not by more than a certain threshold of the saved radio quality. The remote WTRU may make other, similar uses of the given threshold of the saved radio quality.

In examples and embodiments provided herein, a remote WTRU may be configured with multipath operation via an SL relay and configured with measurement/CHO configurations. The remote WTRU may be further configured to stop applying offsets on top of Uu serving cell measurements that depend on the SL radio quality and/or SL CBR/CR, when the Uu radio quality is below a certain configured threshold. In an example, the remote WTRU may stop applying offsets when evaluating A/B events.

Examples and embodiments provided herein include solutions related to measurement report trigger conditions. In examples, Uu measurement trigger conditions may include the CBR of the SL, the CR of the SL, or both the CBR and the CR of the SL. In an example, the remote WTRU may be configured to apply an offset on the serving Uu measurements, where the offset value is a function of the SL CBR/CR of the multipath. For example, the remote WTRU may be configured to apply offset1 if a CBR/CR is below threshold1, apply offset2 if CBR/CR is between threshold1 and threshold2, apply offset3 if CBR/CR is between threshold2 and threshold3, apply no offset if the CBR/CR is above threshold3, and the like. In an example of applying an offset, the remote WTRU may add offset1 to the serving cell measurement before comparing serving cell measurements to a neighbor cell for an A3 event.

In a further example, the remote WTRU may be configured with a baseline offset, for example, baseline_offset, to add to the serving Uu measurements for a certain baseline CBR threshold, for example, cbr1, and a scaling factor/function that is depending on the current CBR as compared to the baseline CBR threshold. For example, the remote WTRU may apply no offset for a CBR above cbr1 and for CBRs below or equal to cbr1, the remote WTRU may calculate the offset to be baseline_offset*(cbr1/Current_CBR)*scaling_factor. A limit could also be specified to make sure the offset will not be increased to a very high value and risk radio link failures. For example, the maximum offset could be configured to be maximum x % of the baseline_offset (where x>1). That is, the offset is now calculated as baseline_offset*min (x, (cbr1/Current_CBR)*configured_scaling_factor). The maximum offset could also be specified in absolute value (max_offset). That is, the offset to be applied is now calculated as min (max_offset, baseline_offset*(cbr1/Current_CBR)*configured_scaling_factor).

In further examples, Uu measurement trigger conditions may include the SL radio quality. In an example, the remote WTRU may be configured to apply an offset on the serving Uu measurements, where the offset value is a function of the SL radio quality of the multipath. For example, the remote WTRU may be configured to apply no offset if the SL radio quality is below threshold1, apply offset1 if SL radio quality is between threshold1 and threshold2, apply offset2 if SL radio quality is between threshold2 and threshold3, apply offset3 if the SL radio quality is above threshold3, and the like. In an example of applying an offset, the remote WTRU may add offset1 to the serving cell measurement before comparing to neighbor cell for an A3 event.

In a further example, the remote WTRU may be configured with a baseline offset, for example, baseline_offset, to add to the serving Uu measurements for a certain baseline SL radio quality, for example, sl_quality1, and a scaling factor/function that is depending on the current SL radio quality as compared to the baseline radio quality. For example, the remote WTRU may determine the offset to be baseline_offset*(current_sL_quality/sl_quality1)*scaling_factor. A limit could also be specified to make sure the offset will not be increased to a very high value and risk radio link failures. For example, the maximum offset could be configured to be maximum x % of the baseline_offset. That is, the offset is now calculated as baseline_offset*min (x, (current_SL_quality/sl_quality1)*configured_scaling_factor). The maximum offset could also be specified in absolute value instead of as a comparison to the baseline (max_offset). That is, the offset to be applied is now calculated as min (max_offset, baseline_offset*(current_SL_quality/sl_quality1)*configured_scaling_factor).

In further examples, SL measurement trigger conditions may include the Uu radio conditions. In an example, the remote WTRU may be configured to modify the threshold to be used in C1 or C2 events depending on the Uu radio conditions. For example, for event C2, the remote WTRU may be configured to apply c2_threshold1 if the Uu radio quality is uu_threshold1, apply c2_threshold2 if the Uu radio quality is between uu_threshold1 and uu_threshold2, apply c2_threshold3 if the Uu radio quality is above uu+ threshold2, and the like.

In a further example, the remote WTRU may be configured with a baseline threshold, for example, c2_baseline_threshold, to use for a C1 event/C2 event for a certain baseline Uu radio quality, for example, uu_threshold1, and a scaling factor/function that is depending on the current Uu radio quality as compared to uu_threshold1. For example, the remote WTRU may apply c2baseline_threshold for Uu radio quality above uu_threshold1 and for Uu radio quality above or equal to uu_threshold1, it calculates the C2 threshold as c2_baseline_threshold*(current_Uu_quality/uu_threshold1)*scaling_factor. A limit could also be specified to make sure the threshold will not be increased to a very high value and risk too much congestion on the SL. For example, the maximum C2 threshold could be configured to be maximum x % of the c2_baseline_threshold (where x>1). That is, the C2 threshold is now calculated c2_baseline_threshold*min (x, (current_Uu_quality/uu_threshold1)*configured_scaling_factor). The maximum c2 threshold could also be specified in absolute value (c2_max_threshold). That is, the C2 threshold is now calculated as min (c2_max_threshold, c2_baseline_threshold*(current_Uu_quality/uu_threshold1)*configured_scaling_factor).

Further examples include combinations of example solutions provided herein. For example, the example solutions provided herein for determining the appropriate offset to apply on top of serving Uu measurements can be combined. For example, the WTRU may consider both SL CBR/CR and SL radio quality (e.g., a certain offset value associated with a CBR value/range and a SL radio quality value/range). A certain SL radio quality threshold may be specified and if the SL radio quality is below this threshold level, the WTRU may not consider SL aspects, for example, use the base line A/B configuration as in legacy. However, if the SL radio quality is above the threshold, then the WTRU may apply the configured offset determination based on the current CBR/CR range/value and the configured mapping between CBR/CR value/range and the offset as discussed above. Also, a certain CBR/CR threshold may be specified and if the SL CBR is above this threshold level, the WTRU may not consider SL CBR aspects. If the SL CBR is below this threshold level, then the WTRU may apply the configured offset determination based on the current SL radio quality value/range and the configured mapping between SL radio quality value/range and the offset as discussed above.

Example solutions and embodiments related to s-measure are provided herein. In examples, an s-measure may consider or may include the CBR/CR of the SL. In an example solution, the s-measure may be used to determine whether the WTRU which performs measurements on neighbor cell takes the SL CBR into consideration when the WTRU is operating in multipath. For example, the remote WTRU may be configured with multiple s-measure thresholds that correspond to different CBR/CR ranges. For example, the remote WTRU may apply threshold1 when the SL CBR is below cbr1, apply threshold2 when the CBR is between cbr1 and cbr2, apply threshold3 when the SL CBR is between cbr2 and cbr3, apply threshold4 when the SL CBR is above cbr3, and the like.

In a further example, the remote WTRU may be configured with a baseline s-measure threshold, for example, s_measure_baseline, that is applicable for a certain baseline CBR threshold, for example, cbr1, and a scaling factor/function that depends on the current CBR as compared to the baseline CBR threshold. For example, the WTRU may determine the s-measure to apply to be equal to the s_measure_baseline if the CBR is above cbr1, and otherwise calculate it as s_measure_baseline*(Current_CBR/cbr1)*configured_scaling_factor. A limit could also be specified to make sure the s-measure will not be decreased to a very low level and risk radio link failures. For example, the minimum s-measure could be configured to be not less than x % of the baseline s-measure (x<1). That is, the s-measure is now evaluated, for CBRs below cbr1, as s_measure_baseline*max (x, (Current_CBR/cbr1)*configured_scaling_factor). The minimum s-measure could also be specified in absolute value (min_s_measure). That is, the s-measure is now evaluated, for CBRs below cbr1, as max (min_s_measure, s_measure_baseline*(Current_CBR/cbr1)*configured_scaling_factor).

In another example, the s-measure may consider or may include SL radio quality. In an example solution, the remote WTRU may be configured with multiple s-measure thresholds that correspond to different SL radio quality ranges. For example, the remote WTRU may apply threshold1 when the SL radio quality is below sl_quality1, apply threshold2 when the SL radio quality is between sl_quality1 and sl_quality2, apply threshold3 when the SL radio quality is above sl_quality2, and the like.

In a further example, the remote WTRU may be configured with a baseline s-measure threshold, for example, s_measure_baseline, that is applicable for a certain baseline SL radio quality, for example, sl_quality1 and a scaling factor/function that depends on the current SL radio quality as compared to the baseline SL radio quality. For example, the remote WTRU may determine the s-measure to apply to be equal to the s_measure_baseline if the SL quality is below sl_quality1, and otherwise calculate it as s-measure-baseline*(sl-quality_1/Current_SL_quality)*configured_scaling_factor. A limit could also be specified to make sure the s-measure will not be decreased to a very low level and risk radio link failures. For example, the minimum s-measure could be configured to be not less than x % (x<1) of the baseline s-measure. That is, the s-measure is now evaluated, for SL radio quality above sl_quality1, as s_measure_baseline*max (x, (sl-quality_1/Current_SL_quality)*configured_scaling_factor). The minimum s-measure could also be specified in absolute value (min_s_measure). That is, the s-measure is now evaluated, for SL radio quality above sl_quality1, as max (min_s_measure, s_measure_baseline*(sl-quality_1/Current_SL_quality)*configured_scaling_factor).

Further examples include combinations of example solutions provided herein. For example, the example solutions provided herein for determining the appropriate s-measure to apply can be combined. For example, a WTRU may consider both SL CBR/CR and SL radio quality, for example, a certain s-measure value associated with a CBR value/range and a SL radio quality value/range.

A certain SL radio quality threshold may be specified and if the SL radio quality is below this level, the WTRU may not consider SL aspects, for example, the WTRU may use the base line s-measure as in legacy. If the SL radio quality is above the threshold, then apply the s-measure determined based on the current CBR/CR range/value and the configured mapping between CBR/CR value/range and the s-measure as discussed above. Further, a certain CBR/CR threshold may be specified and if the SL CBR is above this level, may not consider SL CBR aspects, for example, the WTRU may use the base line s-measure as in legacy. If the SL CBR is below this level, then the WTRU may apply the s-measure determined based on the current SL radio quality value/range and the configured mapping between SL radio quality value/range and the s-measure as discussed above.

Examples including s-measure for the SL and s-measure for the Uu are provided herein. In an example, the solutions for the determination of an appropriate s-measure to apply discussed above are applicable only for determining to start measuring neighbor Uu links. In a further example, the solutions for the determination of appropriate s-measure to apply discussed above are applicable only for determining to start measuring neighbor SL links. In another example, the solutions for the determination of appropriate s-measure to apply discussed above are applicable for determining to start measuring both Uu and SL neighbor links.

In a further example, the remote WTRU may be configured to apply different s-measure configuration in measuring neighbor direct links or neighbor sidelinks. For example, two sets of thresholds concerning the serving Uu radio quality and/or the SL radio quality and/or the CBR/CR may be provided, one for controlling measurements on SL neighbors and another provided for performing measurements on Uu neighbors. In another example, the measurements of SL neighbors may be controlled via thresholds that concern only the sidelink, for example, SL radio quality and/or CBR/CR, and the measurements on Uu neighbors is controlled by the serving Uu radio quality, for example, as in legacy approaches.

In an example, the WTRU may be configured with a baseline s-measure threshold that is used for determining whether to measure neighbor SLs or not, and this threshold is updated based on the Uu radio quality. This approach may be akin to the solutions above for determining the s-measure for the Uu, for example, based on a set of configuration corresponding to range of Uu radio quality values, or based on a scaling factor.

Additional example aspects may include bearer type considerations. In an example, the solutions discussed above for the determination of the offset to apply to the Uu measurements for A/B events and/or the determination of the s-measure may be applicable only if the WTRU has radio bearers that are associated only with the SL. For example, the WTRU may have a bearer that is associated with only the SL path. If no such bearer is configured, the WTRU may apply legacy behavior. For example, if no such bearer is configured, the s-measure and Uu measurements for A/B events may not consider the SL CBR or SL radio quality.

In an example, the solutions discussed above for the determination of the offset to apply to the Uu measurements for A/B events and/or the determination of the s-measure may be applicable if the WTRU has split radio bearers that have the SL as the primary path. If no such bearer is configured, the WTRU may apply legacy behavior. For example, if no such bearer is configured, the s-measure and Uu measurements for A/B events do not consider the SL CBR or SL radio quality.

In a further example, the solutions discussed above for the determination of the offset to apply to the Uu measurements for A/B events and/or the determination of the s-measure may be applicable if the WTRU has split radio bearers, whether the primary path is the SL or the Uu. If no such bearer is configured, the WTRU may apply legacy behavior. For example, if no such bearer is configured, the s-measure and Uu measurements for A/B events do not consider the SL CBR or SL radio quality.

Bearer QoS considerations are included in examples provided herein. In an example, the solutions discussed above for the determination of the offset to apply to the Uu measurements for A/B events and/or the determination of the s-measure can further depend on the QoS of the bearers that the WTRU is configured with.

For example, the configurations may be applicable only if the WTRU has bearers of a certain QoS type. Also, different sets of configurations may be provided, each corresponding to bearers of a certain QoS type. In case the WTRU has bearers of more than one type, one or more of the following may apply.

For example, in case the WTRU has bearers of more than one type, the WTRU may decide to use on the relevant configurations randomly. Further, in case the WTRU has bearers of more than one type, the WTRU may be configured to apply the most strict values. In examples, the WTRU may calculate the offsets to use for all the relevant configurations and use the lowest A3 offset determined, the WTRU may calculate the s-measure according to all the relevant configurations and use the highest s-measure determined, and the like.

Also, in case the WTRU has bearers of more than one type, the WTRU may be configured to apply the least strict values. In examples, the WTRU may calculate the offsets to use for all the relevant configurations and use the highest A3 offset determined, the WTRU may calculate the s-measure according to all the relevant configurations and use the lowest s-measure determined, and the like.

Further, in case the WTRU has bearers of more than one type, the WTRU may be configured to use the (weighted) average values. In examples, the WTRU may use the average of all the offsets calculated according to all the relevant configurations, the WTRU may use the average of all the s-measures calculated according to all the relevant configurations, and the like.

Examples provided herein include consideration of buffer levels. In an example, the solutions discussed above for the determination of the offset to apply to the Uu measurements for A/B events and/or the determination of the s-measure can be further dependent on UL buffer levels. For example, split bearer buffer level consideration may be: applicable if the UL buffer level for at least one split radio bearer that has the Uu as the primary path has passed the split buffer threshold; applicable if the UL buffer level for all split radio bearer that has the Uu as the primary path has passed the split buffer threshold; applicable if the UL buffer level for all the split radio bearers that have the Uu as the primary path is below the split buffer threshold; applicable if the UL buffer level for at least one split radio bearer that has the SL as the primary path has passed the split buffer threshold; applicable if the UL buffer level for all split radio bearer that has the SL as the primary path has passed the split buffer threshold; and/or applicable if the UL buffer level for all the split radio bearers that have the SL as the primary path is below the split buffer threshold.

Further, total UL buffer level consideration may be applicable if the total UL buffer level, both buffered on the Uu and SL path, is above a certain threshold, below a certain threshold, or between two thresholds. Also, total UL buffer level consideration may be applicable if the total UL buffer level for the Uu path is above a certain threshold, below a certain threshold, or between two thresholds. Further, total UL buffer level consideration may be applicable if the total UL buffer level for the SL path is above a certain threshold, below a certain threshold, or between two thresholds. Moreover, the WTRU may apply different configurations for different levels of the total UL buffer, total UL buffer for the Uu, or total UL buffer for the SL.

Examples provided herein include consideration of the relay WTRU RRC state. The main scenario addressed in this disclosure is the case where the relay WTRU is in RRC_CONNECTED and actively being used for UL/DL transmission/reception. However, in some cases, the network may decide to put the relay WTRU in RRC_IDLE or RRC_INACTIVE, for example, for power saving purposes, if the relayed path is not being used that much.

In an example, a relay WTRU that is in RRC_IDLE or RRC_INACTIVE can also be considered in the above solutions for determining the measurement offsets or the s-measure value. In a further example, the remote WTRU may be configured to have a different (sets of) configuration(s) that are applicable to RRC_CONNECTED relays, other (sets of) configuration(s) applicable to RRC_INACTIVE relays and other (sets of) configuration(s) applicable to RRC_IDLE relays. The configuration for the RRC_INACTIVE and RRC_IDLE relays could be the same or different. The remote WTRU, on determining the RRC state of the relay WTRU has changed, may start using the configuration associated with that state.

In another example, the remote WTRU may be configured to have a main configuration or a mine set of configurations that are applicable to RRC_CONNECTED relays and a scaling factor or a delta value to apply for RRC_INACTIVE and RRC_IDLE relay WTRUs. For example, the remote WTRU may calculate the offset to apply to the measurement of the serving cell as offset_1, and on determining the relay WTRU is in RRC_INACTIVE state, and may consider the offset to apply to be offset_1−configured_delta_offset. Similarly for the s-measure, the remote WTRU may apply the s-measure to use when the relay WTRU is in RRC_INACTIVE, to be determined s-measure minus the configured_delta_s_measure. The deltas to apply for the INACTIVE and IDLE relay WTRUs can be the same or different.

Examples provided herein include consideration of cells serving the Uu and the SL. An example addressed herein includes the case where the same cell from the same base station, such as a gNB, is serving both the Uu link and the SL. However, the example solution could be applied to other scenarios as well.

In an example, the WTRU may be configured with one set of configurations to apply when the cells serving the Uu and SL are the same, another set of configuration to apply when the cells are different but belong to the same base station or gNB, and yet another set of configurations to apply when the cells belong to different base stations or gNBs. In a further example, the remote WTRU, on determining that the relay WTRU that was being served by the same cell as the remote WTRU has performed a handover to another cell, may revert to legacy behavior. For example, the remote WTRU may stop considering the SL CBR/CR or radio conditions in measurements of the serving cell or in determining the s-measure to apply.

In another example, the remote WTRU, on determining that the relay WTRU, which was in IDLE/INACTIVE state, that was camping on the same cell as the remote WTRU has performed a cell re-selection to another cell, may revert to legacy behavior. For example, the remote WTRU may stop considering the SL CBR/CR or radio conditions in measurements of the serving cell or in determining the s-measure to apply.

In an additional example, remote WTRU, on determining that the relay WTRU, which was in IDLE/INACTIVE state, has performed a cell re-selection from a different cell to the same cell that is also serving the remote WTRU, may start applying any of the above solutions. For example, the remote WTRU may offset the Uu measurements based on the SL radio and/or CBR.

Examples provided herein include RLF prevention. In some example cases, a remote WTRU may experience an RLF with the Uu while operating in multipath with a SL relay. In an example, in order to prevent RLF, the remote WTRU may be configured with a minimum Uu quality threshold, and when the Uu quality is below this level, the remote WTRU will fall to legacy behavior. For example, when the Uu quality is below this threshold, the offset to apply on the Uu measurements due to the SL will be set to 0, regardless of the SL radio or CBR conditions.

The following examples consider the case where the remote WTRU has been configured to consider the combination of the Uu and SL signaling according to one of the solutions above and the remote WTRU is also configured with a CHO. For example, according to one or more solutions above, the remote WTRU may apply an offset to the Uu measurements based on the SL RSRP and/or CBR.

In an example, when such a WTRU experiences an RLF with the Uu, instead of triggering a re-establishment, the remote WTRU may re-evaluate the CHO trigger conditions, but this time without considering the offset of the SL. Further, if the trigger conditions are fulfilled, the WTRU may execute the CHO instead of triggering a re-establishment.

In another example, such a WTRU may be configured to perform two evaluations for the CHO in parallel, one considering the combination of the Uu and SL, and another one as in legacy, for example, only considering the Uu conditions. In an example of considering the combination of the Uu and SL, the WTRU may applying an offset on the Uu conditions that is dependent on the SL RSRP, dependent on the CBR, or dependent on both. If the CHO conditions according to legacy trigger condition evaluation are fulfilled, and the Uu's radio quality continues decreasing for a certain configured time, the WTRU may execute the concerned CHO even if the CHO trigger condition that considers the combination of the Uu and SL is not fulfilled yet.

In a further example, such a WTRU may be performing two evaluations for the CHO in parallel, one considering the combination of the Uu and SL, and another one as in legacy, for example, only considering the Uu conditions. In an example of considering the combination of the Uu and SL, the WTRU may applying an offset on the Uu conditions that is dependent on the SL RSRP, dependent on the CBR, or dependent on both. If the CHO conditions according to legacy trigger condition evaluation are fulfilled, the WTRU may store the radio quality of the target that fulfilled the conditions, but the WTRU may not execute the CHO. In an example of storying radio quality of the target, the WTRU may store an RSRP condition variable, such as RSRP_stored, or an RSRQ condition variable, such as RSRQ_stored. If the WTRU later on experiences a Uu RLF before the CHO trigger condition that considers the combination of the Uu and SL gets fulfilled, the WTRU may compare the concerned target's current radio conditions, and if the signal level of the target is equal to or greater than the stored radio quality of the target, for example, RSRQ current>RSRQ_stored, the WTRU may execute the CHO towards that target.

In a variant of a previous example solution, the WTRU may be configured to handover to the CHO target even if the target's current one or more radio conditions are not as good as the stored radio quality when the CHO conditions according to a legacy consideration were fulfilled according to legacy CHO evaluation. For example, the WTRU may be configured to execute the CHO as long at the current conditions towards the target are not worse by more than a certain configurable threshold, for example, RSRQ current>RSRQ_stored−threshold.

In further examples, consideration of conditions on both Uu and SL are used. In an additional example, the remote WTRU may be configured with measurements or CHO configurations that consider both the Uu and SL conditions. For example, a new event, Ax could be defined that triggers a measurement report, or executes an associated CHO command, when there is a neighbor Uu that is better than the serving Uu by above a first threshold, the SL radio quality is below a second threshold, and/or the SL CBR/CR is above a third threshold.

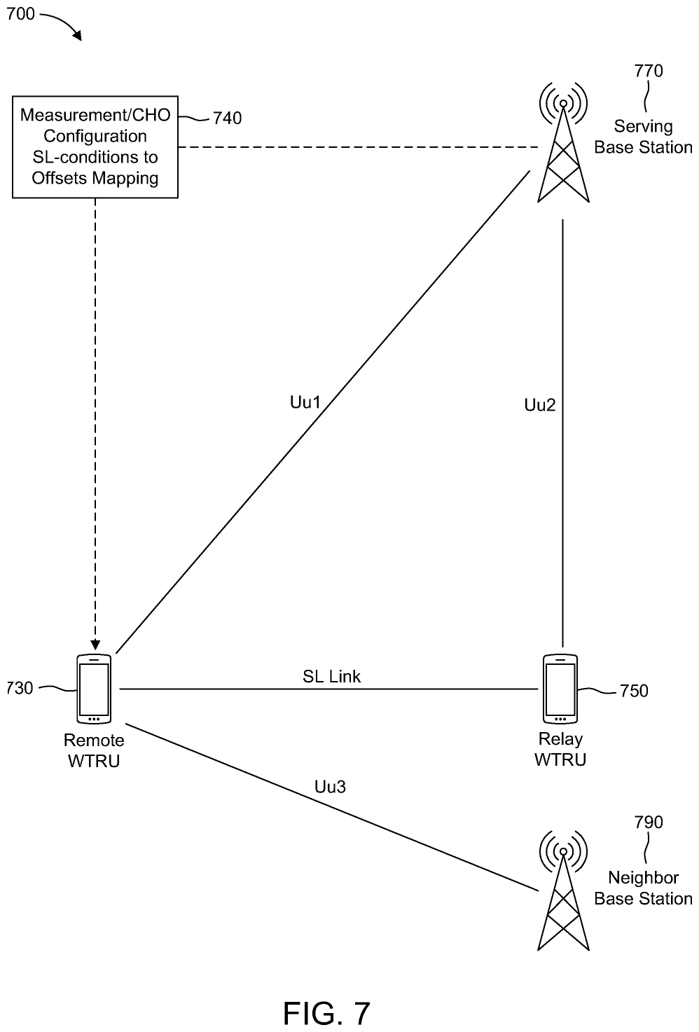

FIG. 7 is a system diagram illustrating an example of wireless communication, including a remote WTRU applying SL conditions to an offsets mapping. As shown in system diagram 700, a WTRU, such as a remote WTRU 730, may be configured with multipath operation via an SL relay and configured with measurement/CHO configurations 740, including an SL conditions to offsets mapping, from serving base station 770. Further, the remote WTRU 730 may be configured to apply different offsets on top of serving cell measurements, for example when evaluating A/B events, corresponding to different values/ranges of SL CBR/CF and/or SL radio quality.

Further, serving base station 770 may also be connected to relay WTRU 750 via a Uu2 link. Remote WTRU 730 may be connected to relay WTRU 750 via an SL link. Moreover, relay WTRU 750 may be connected to a neighbor base station 790 via a Uu3 link.

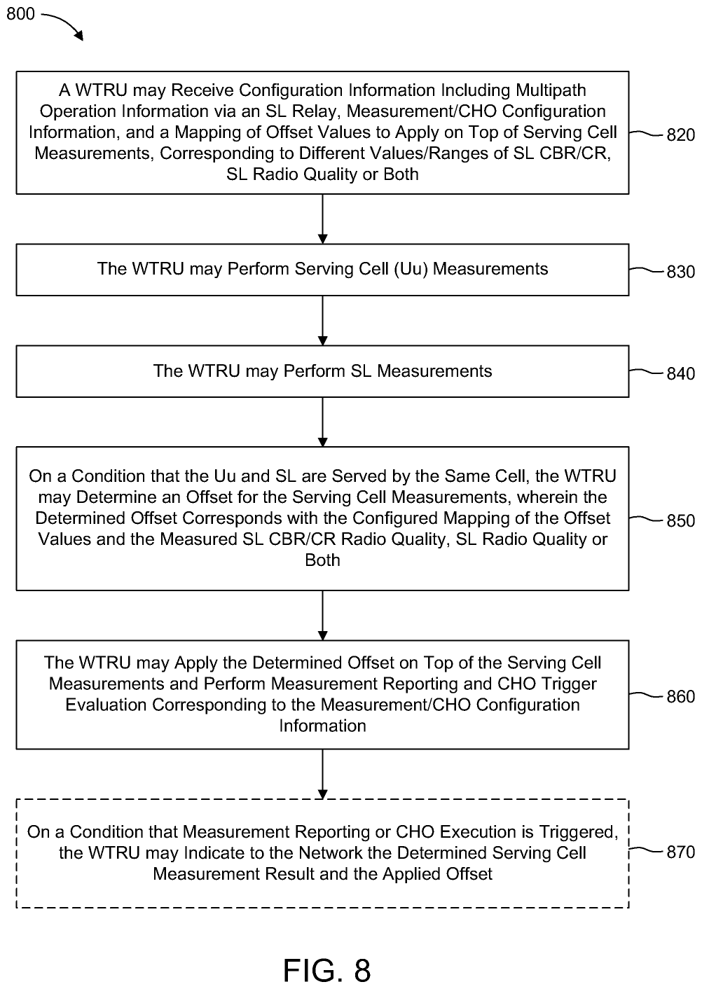

FIG. 8 is a flowchart diagram illustrating an example of wireless communication, including a remote WTRU applying SL conditions to an offsets mapping. In an example shown in flowchart diagram 800, the remote WTRU may receive configuration information including multipath operation information via an SL relay, measurement/CHO configuration information, and a mapping of offset values to apply on top of serving cell measurements, corresponding to different values/ranges of SL CBR/CR, SL radio quality or both 820. Also, the remote WTRU may perform cell measurements or Uu measurements 830. Further, the remote WTRU may perform SL measurements 840. On a condition that the Uu and SL are served by the same cell, the remote WTRU may determine an offset for the serving cell measurements. The offset may correspond with the configured mapping of the offset values and the measured SL CBR/CR radio quality, SL radio quality, or both 850. Further, the remote WTRU may apply the determined offset on top of the serving cell measurements 860. Also, the remote WTRU may perform measurement reporting and CHO trigger evaluation corresponding to the measurement/CHO configuration information. In examples, the evaluation may include evaluating A/B events.

If measurement reporting or CHO execution is triggered, the remote WTRU may indicate to the network the determined serving cell measurement result and the applied offset 870. The remote WTRU may then perform one or more of transmitting SL transmission, transmitting UL transmissions, or receiving DL transmissions, based on the determined serving cell measurement result and the applied offset.

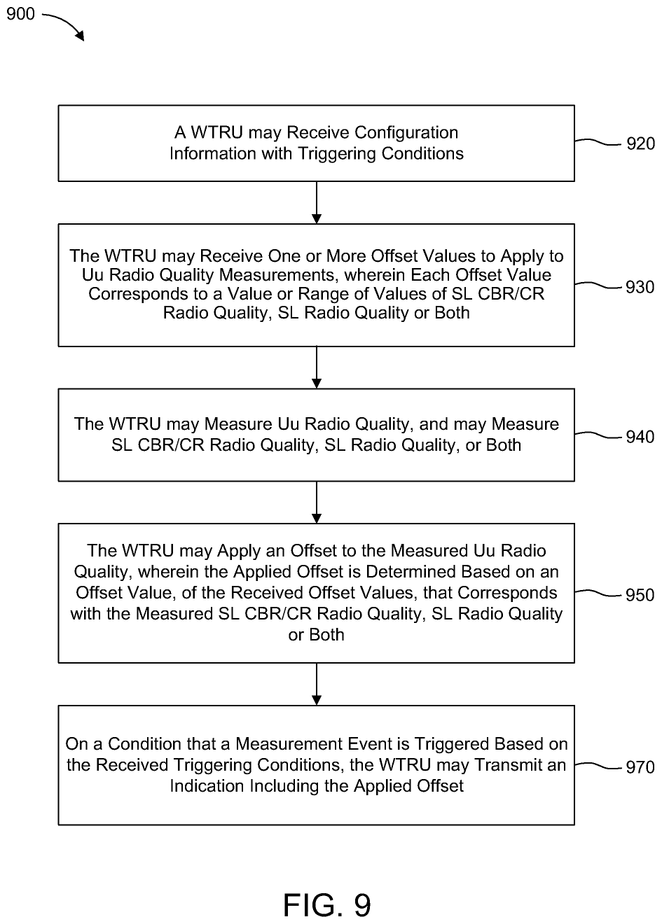

FIG. 9 is another flowchart diagram illustrating an example of wireless communication, including a remote WTRU applying SL conditions to an offsets mapping. In an example shown in flowchart diagram 900, the remote WTRU may receive configuration information with triggering conditions 920. The configuration information may be received from a serving base station. Also, the triggering conditions may be for a measurement event, in an example. Further, the remote WTRU receive may one or more offset values to apply to Uu radio quality measurements, wherein each offset value corresponds to a value or range of values of SL CBR/CR radio quality, SL radio quality or both 930. In an example, the one or more offset values may be receive from the serving base station.

In addition, the remote WTRU may measure Uu radio quality. Further, the remote WTRU may measure SL CBR/CR radio quality, SL radio quality, or both 940.

Further, the remote WTRU may apply an offset to the measured Uu radio quality, wherein the applied offset is determined based on an offset value, of the received one or more offset values, that corresponds with the measured SL CBR/CR radio quality, SL radio quality or both 950. On a condition that the measurement event is triggered based on the received triggering conditions, the remote WTRU may transmit an indication including the applied offset 970.

In a further example, the remote WTRU may transmit a measurement report to the serving base station based on the triggering of the measurement event. Further, the measurement event may be associated with measurement reporting. Also, the indication including the applied offset may be transmitted in the measurement report.

In another example, the remote WTRU may execute a CHO, from the serving base station to a neighbor base station, based on the triggering of the measurement event. In an example, the measurement event may be associated with CHO. Also, the remote WTRU may transmit, to the neighbor base station, the indication including the applied offset. Additionally, the applied offset may be further determined based on the received configuration information. In another example, the configuration information may include one or more of a measurement configuration, a CHO configuration, a measurement reporting configuration, a measurement event configuration, or a reporting configuration.

In an additional example, the triggering conditions may include a condition that the measured SL CBR/CR is below a first threshold. In a further example, the triggering conditions may include a condition that the measured SL CBR/CR is equal to or above a first threshold. In yet another example, the triggering conditions may include a condition that the measured SL radio quality is below a second threshold. In yet an additional example, the triggering conditions include a condition that the measured SL radio quality is equal to or above a second threshold. In yet a further example, the triggering conditions may include a condition that the measured Uu radio quality is below a third threshold. Additionally or alternatively, the triggering conditions include a condition that the measured Uu radio quality is equal to or above a third threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless device, the method comprising:
receiving, from a serving base station, configuration information including triggering conditions for a measurement event;
receiving, from the serving base station, one or more offset values to apply to Uu radio quality measurements, wherein each offset value corresponds to a value or range of values of sidelink (SL) channel busy ratio (CBR)/channel occupation ratio (CR) radio quality, SL radio quality or both;
measuring Uu radio quality;
measuring SL CBR/CR radio quality, SL radio quality, or both;
applying an offset to the measured Uu radio quality, wherein the applied offset is determined based on an offset value, of the received one or more offset values, that corresponds with the measured SL CBR/CR radio quality, SL radio quality or both; and
on a condition that the measurement event is triggered based on the received triggering conditions, transmitting an indication including the applied offset.

2. The method of claim 1, further comprising:
transmitting a measurement report to the serving base station based on the triggering of the measurement event, wherein the measurement event is associated with measurement reporting.

3. The method of claim 2, wherein the indication including the applied offset is transmitted in the measurement report.

4. The method of claim 1, further comprising:
executing a conditional handover (CHO), from the serving base station to a neighbor base station, based on the triggering of the measurement event, wherein the measurement event is associated with CHO; and
transmitting, to the neighbor base station, the indication including the applied offset.

5. The method of claim 1, wherein the applied offset is further determined based on the received configuration information.

6. The method of claim 1, wherein the configuration information includes one or more of a measurement configuration, a CHO configuration, a measurement reporting configuration, a measurement event configuration, or a reporting configuration.

7. The method of claim 1, wherein the triggering conditions include one or more of: a condition that the measured SL CBR/CR is below a first threshold, a condition that the measured SL radio quality is below a second threshold, or a condition that the measured Uu radio quality is below a third threshold.

8. The method of claim 1, wherein the triggering conditions include a condition that the measured SL CBR/CR is equal to or above a first threshold.

9. (canceled)

10. The method of claim 1, wherein the triggering conditions include a condition that the measured SL radio quality is equal to or above a second threshold.

11. (canceled)

12. The method of claim 1, wherein the triggering conditions include a condition that the measured Uu radio quality is equal to or above a third threshold.

13. A wireless transmit/receive unit (WTRU) comprising:
a transceiver; and
a processor operatively coupled to the transceiver; wherein:
the transceiver is configured to receive, from a serving base station, configuration information including triggering conditions for a measurement event;
the transceiver is configured to receive, from the serving base station, one or more offset values to apply to Uu radio quality measurements, wherein each offset value corresponds to a value or range of values of sidelink (SL) channel busy ratio (CBR)/channel occupation ratio (CR) radio quality, SL radio quality or both;
the transceiver and the processor are configured to measure Uu radio quality;
the transceiver and the processor are configured to measure SL CBR/CR radio quality, SL radio quality, or both;
the processor is configured to apply an offset to the measured Uu radio quality, wherein the applied offset is determined based on an offset value, of the received one or more offset values, that corresponds with the measured SL CBR/CR radio quality, SL radio quality or both; and
the transceiver and the processor are configured to transmit, on a condition that the measurement event is triggered based on the received triggering conditions, an indication including the applied offset.

14. The WTRU of claim 13, wherein the transceiver and the processor are further configured to transmit a measurement report to the serving base station based on the triggering of the measurement event, wherein the measurement event is associated with measurement reporting.

15. The WTRU of claim 14, wherein the indication including the applied offset is transmitted in the measurement report.

16. The WTRU of claim 11, wherein the transceiver and the processor are further configured to execute a conditional handover (CHO), from the serving base station to a neighbor base station, based on the triggering of the measurement event, wherein the measurement event is associated with CHO; and wherein the transceiver and the processor are further configured to transmit, to the neighbor base station, the indication including the applied offset.

17. The WTRU of claim 11, wherein the applied offset is further determined based on the received configuration information.

18. The WTRU of claim 11, wherein the configuration information includes one or more of a measurement configuration, a CHO configuration, a measurement reporting configuration, a measurement event configuration, or a reporting configuration.

19. The WTRU of claim 11, wherein the triggering conditions include one or more of: a condition that the measured SL CBR/CR is below a first threshold, a condition that the measured SL radio quality is below a second threshold, or a condition that the measured Uu radio quality is below a third threshold.

20. The WTRU of claim 11, wherein the triggering conditions include a condition that the measured SL CBR/CR is equal to or above a first threshold.

21. (canceled)

22. The WTRU of claim 11, wherein the triggering conditions include a condition that the measured SL radio quality is equal to or above a second threshold.

23. (canceled)

24. The WTRU of claim 11, wherein the triggering conditions include a condition that the measured Uu radio quality is equal to or above a third threshold.
